(19) United States
(12) Patent Application Publication
(10) Pub. No.: US 2026/0210260 A1
(43) Pub. Date: Jul. 23, 2026

(54) TURBOMACHINE COMPRESSOR EXIT REGION SEAL FLOW CIRCUIT

(71) Applicant: GE Vernova Infrastructure Technology LLC, Greenville, SC (US)

(72) Inventors: Debabrata MUKHOPADHYAY, Karnataka (IN); Veerraju CHENNOJU, Karnataka (IN)

(21) Appl. No.: 19/144,301

(22) PCT Filed: Dec. 19, 2023
(86) PCT No.: PCT/US2023/084813

§ 371 Date: Jun. 27, 2025

(30) Foreign Application Priority Data
Dec. 28, 2022 (IN) 202211076601

(51) Int. Cl. F01D 11/02

(52) U.S. Cl. CPC F01D 11/02; F05D 2220/32; F05D 2240/55

(57) ABSTRACT

A turbomachine compressor includes a final stage of vanes having tip shrouds in a circumferential groove of an inner casing. Each tip shroud defines a downstream opening with an aft wall of the groove. Under each tip shroud, an exit channel extends to a high pressure packing seal (HPPS) cavity to reduce leakage of fluid from downstream to an area upstream of the final stage of vanes. A first seal in the circumferential groove diverts compressed gas entering the downstream opening into the HPPS cavity. The exit channel can extend axially or radially, and a second seal may be included between the exit channel and the downstream opening for a radial exit channel.

### TECHNICAL FIELD

The disclosure relates generally to gas turbine compressor seal flow management and a flow circuit therefor. More specifically, the disclosure is directed to a flow circuit for use with a seal arrangement for a vane in an exit region of a turbomachine compressor, such as a final stage stator vane.

### BACKGROUND

Pressure loss at various locations in a turbomachine leads to a reduction in working efficiency, particularly when it occurs through seals of components in a flow path through the turbomachine. For example, a turbomachine with a cold gas path includes a compressor having vanes in an exit region, such as final stage stators, which can have tip shrouds that can reside in a circumferential groove in an inner casing of the turbomachine and that can be attached to the vanes via mounting hardware, such as bolts, bushings, and the like. Tolerances and clearances of the tip shrouds and the circumferential groove can result in fore and aft openings defined by the fore and aft ends of the tip shrouds and the fore and aft ends of the circumferential groove, as well as a path through a gap between the mounting hardware and a bottom wall of the circumferential groove, through which leakage can occur during operation. To reduce leakage, in previous arrangements, a brush seal has been placed between the bottom wall of the circumferential groove and the tip shroud. While previous arrangements including brush seals sufficiently reduced leakage through the circumferential groove under the tip shrouds, changes to the circumferential groove, the tip shrouds, and/or mounting hardware can render such seals less effective. Consequently, a turbomachine with such changed components may experience more pressure loss than desired as compressed gas passes through brush seal(s) under the base of the vane(s). This can lead to the leaked compressed gas being reintroduced into the main flow path before the vane(s), which is undesirable because it can create aerodynamic issues in the turbomachine during operation. Additionally, compressor efficiency is adversely affected.

### BRIEF DESCRIPTION

All aspects, examples and features mentioned below can be combined in any technically possible way.

An aspect of the disclosure provides a high pressure packing seal (HPPS) circuit apparatus for a turbomachine comprising a circumferential groove in an inner casing of the turbomachine, the circumferential groove extending substantially radially inward from an outer surface of the inner casing and having a bottom wall, a forward wall, and an aft wall; an HPPS cavity defined by the inner casing and a rotor of the turbomachine and including an HPPS inlet between the forward portion of the inner casing and an aft end of a compressor portion of the rotor of the turbomachine; a vane mounted in an outer casing of the turbomachine and extending to the inner casing, the vane having a tip disposed at the circumferential groove; a tip shroud of the vane extending from the tip and having an outer surface substantially coplanar with the outer surface of the inner casing and an inner surface disposed in the circumferential groove, the tip shroud and the forward wall of the circumferential groove defining an upstream opening, and the tip shroud and the aft wall of the circumferential groove defining a downstream opening; a first seal mounted in the circumferential groove and extending toward the tip shroud of the vane and having a first clearance therewith; and an exit channel extending from the circumferential groove through the inner casing to the HPPS cavity.

Another aspect of the disclosure includes any of the preceding aspects, and the first seal is mounted on the bottom wall of the circumferential groove;

Another aspect of the disclosure includes and of the preceding aspects, and the exit channel extends substantially parallel to an axis of rotation of the turbomachine from the forward wall of the circumferential groove to the forward portion of the inner casing.

Another aspect of the disclosure includes any of the preceding aspects, and the exit channel is angled in a circumferential direction to induce swirl in gases in the HPPS cavity.

Another aspect of the disclosure includes any of the preceding aspects, and the exit channel is one of a plurality of exit channels, each exit channel of the plurality of exit channels having a respective exit hole; the first seal is a labyrinth seal including two teeth with a clearance of from about 0.254 millimeters (mm) to about 4 mm; and a diameter of each exit hole is from about 2.54 mm to about 25.4 mm.

Another aspect of the disclosure includes any of the preceding aspects, and the vane is one of a plurality of circumferentially arranged vanes each having a respective tip shroud in the circumferential groove; and wherein a total area of all of the plurality of exit channels is at least 23 cm².

Another aspect of the disclosure includes any of the preceding aspects, and the exit channel is one of a plurality of exit channels, each exit channel of the plurality of exit channels having a respective exit hole; the first seal is a labyrinth seal including two teeth with about 4 mm clearance; and a diameter of each exit hole is from about 10 mm to about 13 mm.

Another aspect of the disclosure includes any of the preceding aspects, and further comprising a second seal disposed between the first seal and the downstream opening.

Another aspect of the disclosure includes any of the preceding aspects, and the exit channel extends substantially radially from the bottom wall of the circumferential groove to the HPPS cavity.

Another aspect of the disclosure includes any of the preceding aspects, and the exit channel extends from a location in the circumferential groove between the first seal and the downstream opening.

Another aspect of the disclosure includes any of the preceding aspects, and further comprising a second seal between the exit channel and the downstream opening.

Another aspect of the disclosure includes any of the preceding aspects, and the first seal is a labyrinth seal having one tooth and the second seal is a labyrinth seal having two teeth.

Another aspect of the disclosure provides a seal apparatus for a turbomachine, the apparatus comprising a first seal extending between a tip shroud of a vane of the turbomachine and a wall of a circumferential groove in an inner casing of the turbomachine, the first seal disposed between a mount of the tip shroud and a forward wall of the circumferential groove; and an exit channel extending from the circumferential groove to an HPPS cavity defined by a rotor of the turbomachine and the inner casing, whereby during operation of the turbomachine, fluid entering a downstream opening of the circumferential groove is directed through the exit channel to the HPPS cavity.

Another aspect of the disclosure includes any of the preceding aspects, and the exit channel extends substantially parallel to an axis of rotation of the turbomachine from the circumferential groove to a forward portion of the inner casing that is perpendicular to the axis of rotation of the turbomachine.

Another aspect of the disclosure includes any of the preceding aspects, and further including an exit hole of the exit channel formed in the forward portion of the inner casing and an entry hole formed in a forward wall of the circumferential groove.

Another aspect of the disclosure includes any of the preceding aspects, and the first seal is a labyrinth seal including two teeth.

Another aspect of the disclosure includes any of the preceding aspects, and further comprising a second seal disposed between the first seal and a downstream opening defined by the circumferential groove and the tip shroud.

Another aspect of the disclosure includes any of the preceding aspects, and the exit channel extends substantially radially from the circumferential groove to the HPPS cavity.

Another aspect of the disclosure includes any of the preceding aspects, and the exit channel extends from a location in the circumferential groove between the first seal and the downstream opening.

Another aspect of the disclosure includes any of the preceding aspects, and the first seal is a labyrinth seal having one tooth and the second seal is a labyrinth seal having two teeth.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a cross-sectional view of an example turbomachine (e.g., a gas turbine engine) in which aspects of embodiments disclosed herein may be deployed;

FIG. 2 is an enlarged cross-sectional view of an exit region of a compressor of a turbomachine (e.g., the gas turbine engine of FIG. 1), in which a seal arrangement according to embodiments of the disclosure can be deployed;

FIG. 3 is an elevation view of a portion of a final stator stage of a turbomachine compressor in which a seal arrangement according to embodiments of the disclosure can be deployed, illustrating the circumferential arrangement of stator vanes at an inner casing thereof.

FIG. 4 is an enlarged cross-sectional view of an exit region of a compressor of a turbomachine illustrating possible leakage paths that may occur with conventional seal arrangements and that can be mitigated using a seal arrangement according to embodiments of the disclosure;

FIG. 5 is an enlarged cross-sectional view of a vane tip area in an exit region of a compressor of a turbomachine in which a seal arrangement according to embodiments of the disclosure has been deployed;

FIG. 6 is an enlarged cross-sectional view of a vane tip area in an exit region of a compressor of a turbomachine in which a seal arrangement according to embodiments of the disclosure has been deployed;

FIG. 7 is an enlarged cross-sectional view of a vane tip area in an exit region of a compressor of a turbomachine in which a seal arrangement according to embodiments of the disclosure has been deployed;

FIG. 8 is an aftward view of a face of an inner casing of a turbomachine in which a seal arrangement according to embodiments of the disclosure has been deployed and illustrating an arrangement of root exit channels according to embodiments of the disclosure;

FIG. 9 is an enlarged cross-sectional view of a vane tip area in an exit region of a compressor of a turbomachine in which a seal arrangement according to embodiments of the disclosure has been deployed; and

FIG. 10 is an enlarged cross-sectional view of a vane root area in an exit region of a compressor of a turbomachine in which a seal arrangement according to embodiments of the disclosure has been deployed and in which an alternative exit channel arrangement is used.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current disclosure, it will become necessary to select certain terminology when referring to and describing relevant compositions for machine components within turbomachinery. To the extent possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbomachine or, for example, the flow of air through the combustor or coolant through one of the turbomachine's component systems. The term “downstream” corresponds to the direction of flow of the fluid, and the term “upstream” refers to the direction opposite to the flow. It is recognized that in an opposed flow configuration, upstream and downstream directions may change depending on where one is in the turbomachine. The terms “forward” and “aft,” without any further specificity, refer to directions, with “forward” or “fore” referring to the front end of the turbomachine, and “aft” or “aftward” referring to the rearward of the turbomachine.

It is often required to describe parts that are at different radial positions with regard to a center axis. The term “radial” refers to movement or position perpendicular to an axis. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis. It will be appreciated that such terms may be applied in relation to the center axis of the turbomachine system, e.g., an axis of a rotor thereof.

The terminology used herein is for the purpose of describing particular embodiments only and is not intended to be limiting of the disclosure. The terms “first,” “second,” and “third” may be used interchangeably to distinguish one component from another and are not intended to signify location or importance of the individual components. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described event or circumstance may or may not occur or that the subsequently described component or element may or may not be present, and that the description includes instances where the event occurs or the component is present and instances where it does not or is not present.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, no intervening elements or layers are present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

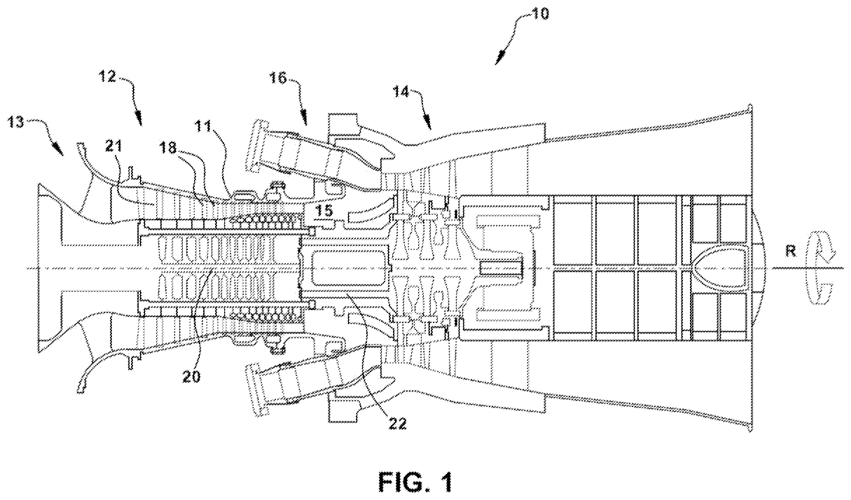

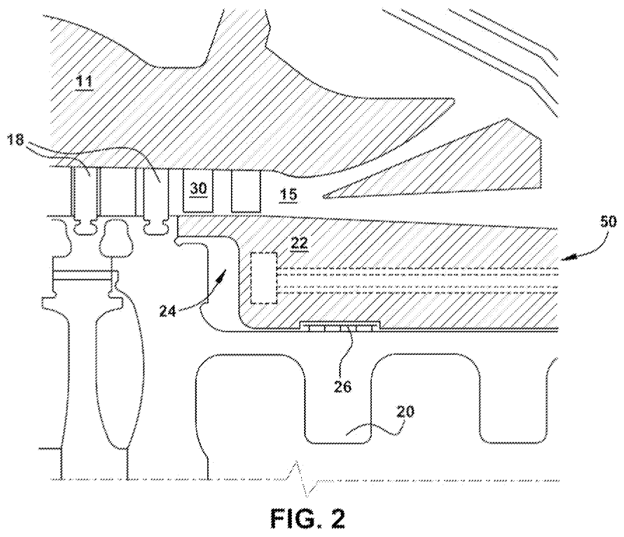

As seen in FIG. 1, a turbomachine 10 (e.g., a gas turbine engine) can include an outer casing 11 that may house a compressor 12, a turbine 14, and combustors 16 that burn fuel to produce hot gas that can drive turbine 14. Turbine 14 is mechanically connected to compressor 12, such as by a rotor 20, so when turbine 14 is driven by hot gas from combustors 16, it drives compressor 12. Compressor 12 includes a plurality of blades and vanes 18, including alternating rows of rotor blades mounted on rotor 20 and stator vanes mounted on an inner casing 22 and extending into a work flow path 21 of compressor 12. Each set of blades and vanes is circumferentially distributed about an axis of rotation R of the turbomachine. The alternating rotor blades and stator vanes can be arranged in a series of stages such that, during operation, air received through an inlet 13 is progressively compressed to higher and higher pressures until, with additional reference to FIG. 2, the compressed air passes a final stage of stator vanes 30 into a compressor exit cavity 15. The compressed air can then be fed to combustors 16, cooling circuits, and other systems of turbomachine 10.

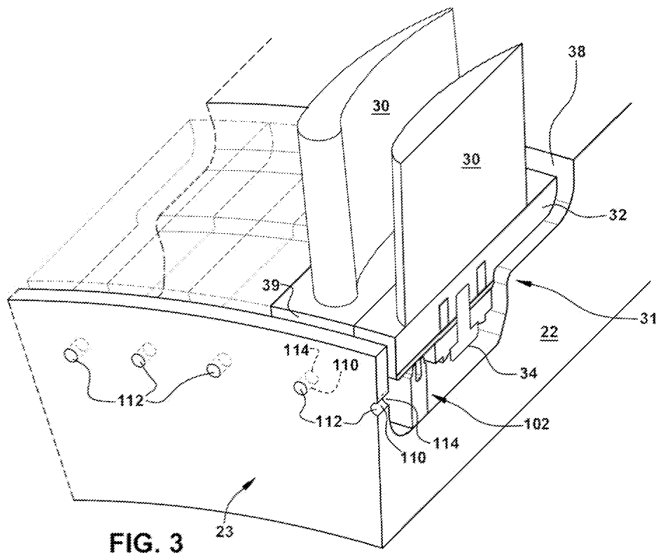

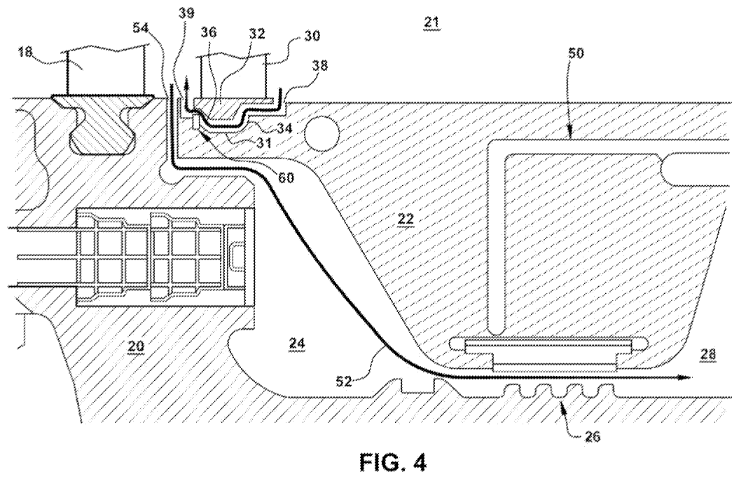

FIG. 3 illustrates an arrangement of vanes 30 in which sealing embodiments of the present disclosure can be employed. More specifically, an inner casing 22 of turbomachine 10 can include a circumferential groove 31 toward which vanes 30 extend from their mounting points (not shown) in, for example, outer casing 11. Vanes 30 can include tip shrouds 32 disposed in circumferential groove 31 so that adjacent tip shrouds engage each other to form a segmented ring. Each tip shroud 32 can be mounted on a respective vane 30 by a mount 34, which can include hardware, such as bushings, bolts, and the like as is understood in the art. Additional aspects of FIG. 3 will be discussed after addressing FIG. 4.

Turning to FIG. 4, an issue that can arise when using a conventional brush seal 60 and high pressure packing seal (HPPS) circuit 50 with a vane 30 mounted with a new mount 34 is schematically illustrated. As shown, tip shroud 32 of vane 30, such as a stator vane, can be retained, via mount 34, in circumferential groove 31 of inner casing 22 of turbomachine 10. HPPS circuit 50 can be configured to conduct fluid in an HPPS flow path 52 from an inlet 54 upstream of vane 30 through an HPPS cavity 24 defined by a forward portion 23 (FIG. 3) of inner casing 22 and surfaces of rotor 20 of turbomachine 10 aft of blades 18 of compressor 12. Specifically, the HPPS cavity 50 includes an HPPS inlet between the forward portion 23 of inner casing 22 and an aft end of a compressor portion of rotor 20 of turbomachine 10. HPPS flow path 52 can continue between surfaces of inner casing 22 and rotor 20 across a HPPS 26 to a downstream cavity 28 of turbomachine 10, such as a turbine wheel cavity. Downstream cavity 28 can be defined in part by surfaces of inner casing 22 and rotor 20 aft of HPPS 26.

Circumferential groove 31 and tip shroud 32 collectively define a downstream opening 38 to compressor work flow path 21, as well as an upstream opening 39 to compressor work flow path 21. FIG. 4 shows a conventional brush seal 60 in circumferential groove 31 and illustrates a groove flow 36 from downstream opening 38 to upstream opening 39 and into work flow path 21 upstream of vane 30 that can result from some mounts 34. As should be understood, the vane 30 is one of a plurality of circumferentially distributed vanes 30 on inner casing 22, each having respective mounts 34 and associated components. Consequently, the illustrated downstream and upstream openings 38, 39 are parts of downstream and upstream circumferential gaps between tip shrouds 32 and forward and aft walls of circumferential groove 31, as can be seen in FIG. 3.

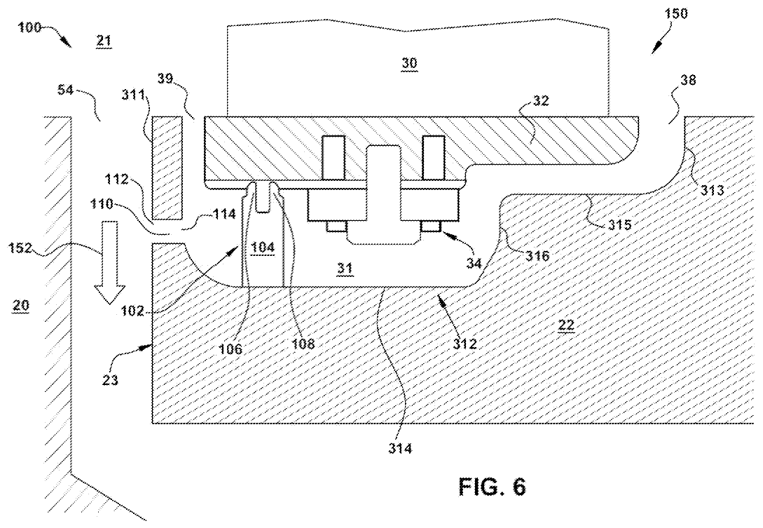

With reference now to FIGS. 3 and 5-8, a seal arrangement 100 according to embodiments of the disclosure can have a first seal 102 in circumferential groove 31 beneath vane 30. As particularly seen in FIG. 6, circumferential groove 31 can have a forward wall 311, a bottom wall 312, and an aft wall 313. In embodiments, bottom wall 312 can include a forward portion 314 and an aft portion 315 with a step 316 therebetween such that forward portion 314 is deeper into inner casing 22 than aft portion 315. Such a step 316 in bottom wall 312 can allow adequate space for mount 34 and parts of tip shroud 32 in forward portion 314 while reducing space between tip shroud 32 and rear portion 315, thereby reducing leakage through circumferential groove 31 during operation of turbomachine 10.

As indicated above, each tip shroud 32 with circumferential groove 31 can define a downstream opening 38 to work flow path 21 at a downstream end of the respective vane 30 and an upstream opening 39 to work flow path 21 at an upstream end of the respective vane 30. More specifically, downstream opening 38 can be defined by tip shroud 32 and aft wall 313, and upstream opening 39 can be defined by tip shroud 32 and forward wall 311. First seal 102 can, for example, extend radially between tip shroud 32 and inner casing 22. A respective exit channel 110 can extend from circumferential groove 31 to HPPS cavity 24 to fluidly connect these areas, whereby during operation of turbomachine 10, fluid entering downstream opening 38 of circumferential groove 31 is directed through exit channel 110 to HPPS flow path 52, effectively creating a modified HPPS flow path 152 of a modified HPPS circuit 150. That is, a forward/upstream HPPS inward flow drawn into HPPS inlet 54 by modified HPPS circuit 150 can combine with modified groove flow 136 to form modified HPPS circuit flow in modified HPPS flow path 152.

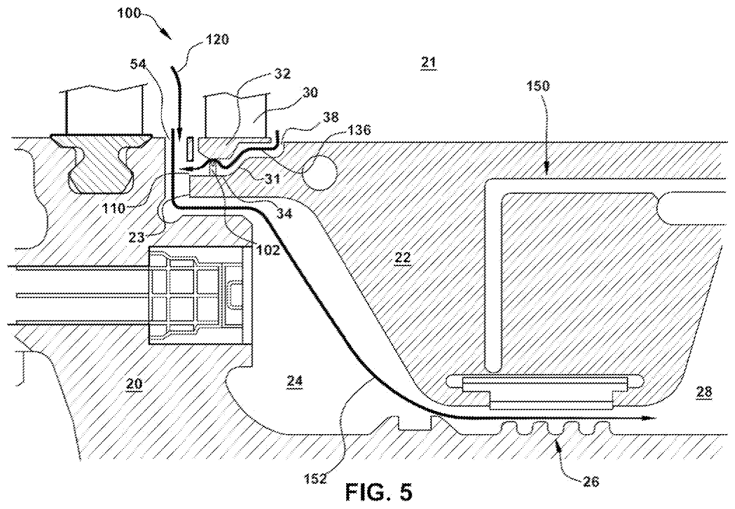

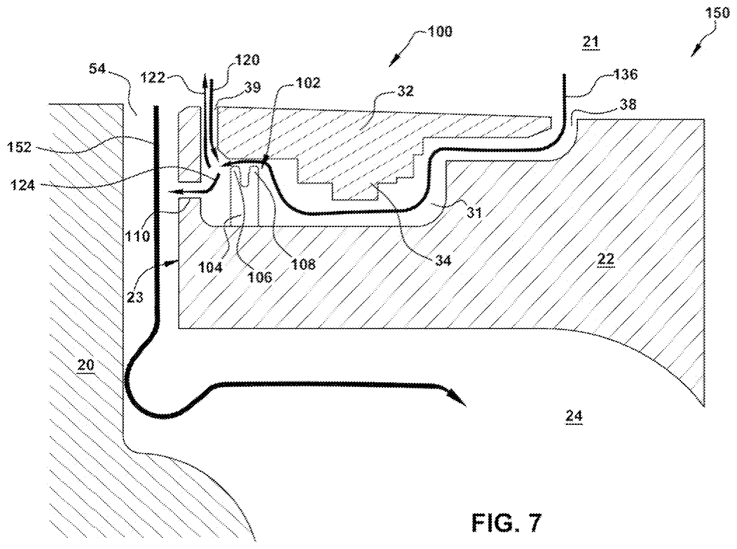

As seen in FIGS. 6 and 7, first seal 102 can include a base 104 with at least one tooth 106, 108 extending therefrom. The particular example illustrated shows two teeth 106, 108 on first seal 102, but other numbers of teeth can be used as desired and appropriate, and/or depending on other factors of arrangement 100. As particularly seen in FIGS. 5 and 7, first seal 102 can interact with modified root cavity flow 136, upstream root inward flow 120, upstream root outward flow 122, and/or axial root exit flow 124. First seal 102 and root exit channel 110 can advantageously be tuned to minimize upstream root outward flow 122 so that modified root cavity flow 136 and upstream root inward flow 120 combine to form root exit flow 124.

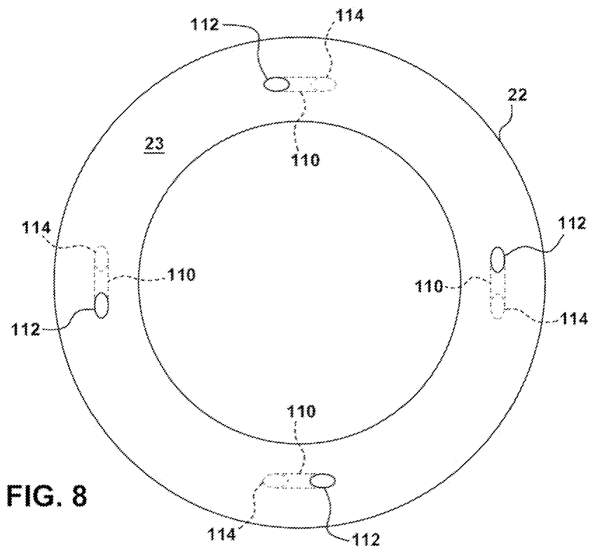

With additional reference to FIG. 8, each exit channel 110 can include an exit hole 112 at forward portion 23 of inner casing 22. Each exit channel 110 extends substantially parallel to an axis of rotation R (FIG. 1) of turbomachine 10 from a respective entry hole 114 in forward wall 311 of circumferential groove 31. Each exit hole 112 in embodiments can be circumferentially spaced from its respective entry hole 114 such that exit channel 110 is angled in a circumferential direction to induce swirl in gases in HPPS cavity 24 during operation of turbomachine 10. For example, the spacing can yield an orientation or angle of exit channels 110 of from about 5° to about 90° relative to a plane of the forward portion 23 of inner casing 22 to or relative to a tangential plane.

It should be noted that the numbers of seals, numbers of teeth in the seals, and clearances of the teeth can be varied to tune embodiments for the aerodynamic requirements of work flow path 21 in a given installation. In some embodiments, the teeth can have a clearance of from about 0.25 millimeters (mm) to about 4 mm. In addition, the number and sizes of the exit channels 110, entry holes 114, and exit holes 112 can also be varied to tune embodiments. For example, in some embodiments, there can be from 20 to 50 exit channels 110, and the diameters of the exit holes 112 can be from about 2.5 mm to about 25.4 mm in diameter. In other embodiments, exit holes 112 can have diameters of no more than about 20.3 mm.

In the example of embodiments illustrated in FIGS. 5-7, first seal 102 can be a labyrinth seal including two teeth 106, 108 having have a clearance of from about 0.40 mm to about 0.60 mm. In such embodiments, 30 to 40 exit channels 110 can be used, and exit holes 112 can have a diameter of from about 10 mm to about 13 mm such that a total area of all of the exit holes is at least 23cm². Good results can be achieved using a tooth clearance of about 0.50 mm and as many as 40 exit channels 110 with exit holes 112 of about 10.1 mm in diameter. Employing these criteria can significantly reduce flow from circumferential groove 31 through upstream opening 39 into work flow path 21.

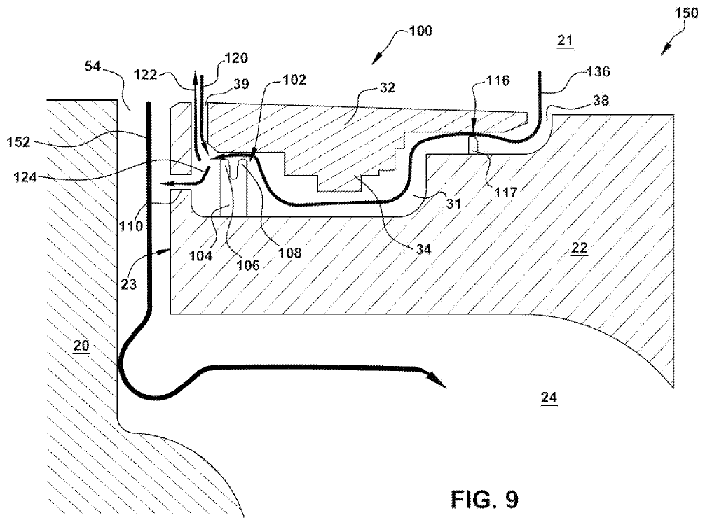

In other embodiments, first seal 102 can be a labyrinth seal including two teeth 106, 108 with as much as about 4 mm tooth clearance with 45-50 exit channels 110 and exit holes 112 having a diameter of from 10 mm to about 13 mm, such as about 12.7 mm. In such embodiments, with additional reference to FIG. 9, a second seal 116 can be disposed between first seal 102 and downstream opening 38 of circumferential groove 31. For example, second seal 116 can be a labyrinth seal having one tooth 117.

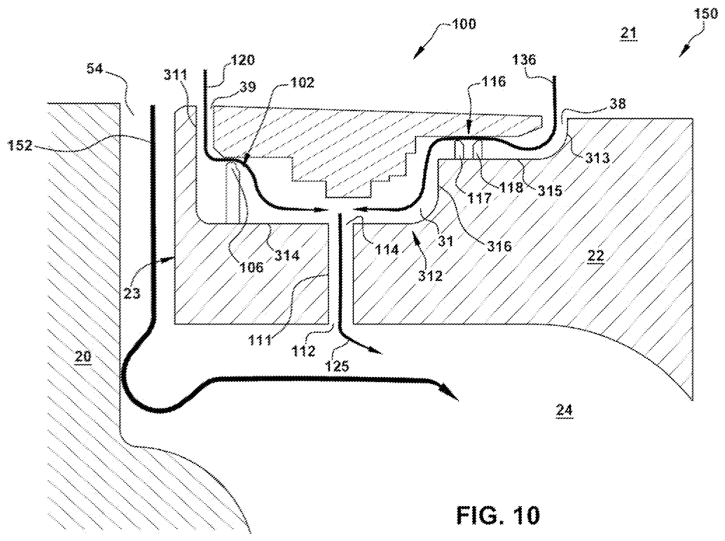

Turning now to FIG. 10, an alternative configuration of arrangement 100 is illustrated in which each exit channel is a radial exit channel 111 that can extend substantially radially from circumferential groove 31 to HPPS cavity 24 between rotor 20 and inner casing 22. In such a configuration, each exit channel 111 can extend through entry hole 114 formed in bottom wall 312 between first seal 106 and downstream opening 38. For example, entry hole 314 can be formed in forward portion 314 of bottom wall 312, though it could instead be formed in aft portion 315 if desired and/or appropriate. In addition, similar to the example of FIG. 9, arrangement 100 can further include a second seal 116 between exit channel 111 and downstream opening 38 of circumferential groove 31.

In embodiments, first seal 102 can be a labyrinth seal having, for example, one tooth 106, and second seal 116 can be a labyrinth seal having, for example, two teeth 117, 118. As with embodiments described above, first seal 102, second seal 116, and/or radial exit channel 111 can be configured so that upstream root inward flow 120 and modified root cavity flow 136 combine to form radial root exit flow 125 to HPPS cavity 24, forming modified HPPS flow in modified HPPS flow path 152. In addition, similar to exit channel 110, radial exit channel 111 can be inclined to induce swirl in radial root exit flow 125, such as being angled in a circumferential direction by from about 5° to about 90°.

Using a seal flow circuit or seal arrangement 100 as described herein, a technical effect is improved operational efficiency of turbomachine 10 since reintroduction of fluid into an area upstream of vane 30 can be significantly reduced. This can be achieved because the presence of first seal 102 in circumferential groove 31, according to various embodiments presented herein, diverts fluid entering circumferential groove 31 from downstream opening 38 into HPPS cavity 24 via exit channel 110, or radial exit channel 111 in embodiments, where it can join HPPS flow in modified HPPS flow path 152, rather than allowing the fluid to pass through upstream opening 39 into work flow path 21 upstream of vane 30.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. As used herein, “about” and approximately“ indicates +/−10% of the value, or if a range, of the values stated.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of such technology and to enable others of ordinary skill in the art to understand the various embodiments of the present disclosure and the possibility of various modifications of the disclosed embodiments, as may be suited to the particular use(s) contemplated.

1. A high pressure packing seal (HPPS) circuit apparatus for a turbomachine comprising:
a circumferential groove in an inner casing of the turbomachine, the circumferential groove extending substantially radially inward from an outer surface of the inner casing and having a bottom wall, a forward wall, and an aft wall;
an HPPS cavity defined by the inner casing and a rotor of the turbomachine and including an HPPS inlet between the forward portion of the inner casing and an aft end of a compressor portion of the rotor of the turbomachine;
a vane mounted in an outer casing of the turbomachine and extending to the inner casing, the vane having a tip disposed at the circumferential groove;
a tip shroud of the vane extending from the tip and having an outer surface substantially coplanar with the outer surface of the inner casing and an inner surface disposed in the circumferential groove, the tip shroud and the forward wall of the circumferential groove defining an upstream opening, and the tip shroud and the aft wall of the circumferential groove defining a downstream opening;
a first seal mounted in the circumferential groove and extending toward the tip shroud of the vane and having a first clearance therewith; and
an exit channel extending from the circumferential groove through the inner casing to the HPPS cavity,
wherein the exit channel extends substantially parallel to an axis of rotation of the turbomachine from the forward wall of the circumferential groove to the forward portion of the inner casing.

2. The apparatus according to claim 1, wherein the first seal is mounted on the bottom wall of the circumferential groove.

3. (canceled)

4. The apparatus according to claim 1, wherein the exit channel is angled in a circumferential direction to induce swirl in gases in the HPPS cavity.

5. The apparatus according to claim 1, wherein the exit channel is one of a plurality of exit channels, each exit channel of the plurality of exit channels having a respective exit hole; wherein the first seal is a labyrinth seal including two teeth with a clearance of from about 0.25 millimeters (mm) to about 4 mm; and wherein a diameter of each exit hole is from about 2.5 mm to about 25.4 mm.

6. The apparatus according to claim 5, wherein the vane is one of a plurality of circumferentially arranged vanes each having a respective tip shroud in the circumferential groove; and wherein a total area of all of the plurality of exit channels is at least 23cm².

7. The apparatus according to claim 1 3, wherein the exit channel is one of a plurality of exit channels, each exit channel of the plurality of exit channels having a respective exit hole; wherein the first seal is a labyrinth seal including two teeth with about 4 mm clearance; and wherein a diameter of each exit hole is from about 10 mm to about 13 mm.

8. The apparatus according to claim 7, further comprising a second seal disposed between the first seal and the downstream opening.

9. The apparatus according to claim 1, wherein the exit channel extends substantially radially from the bottom wall of the circumferential groove to the HPPS cavity.

10. The apparatus according to claim 9, wherein the exit channel extends from a location in the circumferential groove between the first seal and the downstream opening.

11. The apparatus according to claim 9, further comprising a second seal between the exit channel and the downstream opening.

12. The apparatus according to claim 11, wherein the first seal is a labyrinth seal having one tooth, and the second seal is a labyrinth seal having two teeth.

13. A seal apparatus for a turbomachine, the apparatus comprising:
a first seal extending between a tip shroud of a vane of the turbomachine and a wall of a circumferential groove in an inner casing of the turbomachine, the first seal disposed between a mount of the tip shroud and a forward wall of the circumferential groove; and
an exit channel extending from the circumferential groove to an HPPS cavity defined by a rotor of the turbomachine and the inner casing, whereby, during operation of the turbomachine, fluid entering a downstream opening of the circumferential groove is directed through the exit channel to the HPPS cavity,
wherein the exit channel extends substantially parallel to an axis of rotation of the turbomachine from the circumferential groove to a forward portion of the inner casing that is perpendicular to the axis of rotation of the turbomachine.

14. (canceled)

15. The apparatus according to claim 13, further including an exit hole of the exit channel formed in the forward portion of the inner casing and an entry hole formed in a forward wall of the circumferential groove.

16. The apparatus according to claim 13, wherein the first seal is a labyrinth seal including two teeth.

17. The apparatus according to claim 13, further comprising a second seal disposed between the first seal and a downstream opening defined by the circumferential groove and the tip shroud.

18. The apparatus according to claim 17, wherein the exit channel extends substantially radially from the circumferential groove to the HPPS cavity.

19. The apparatus according to claim 18, wherein the exit channel extends from a location in the circumferential groove between the first seal and the downstream opening.

20. The apparatus according to claim 18, wherein the first seal is a labyrinth seal having one tooth, and the second seal is a labyrinth seal having two teeth.
